(19) United States
(12) Patent Application Publication
(10) Pub. No.: US 2013/0045771 A1
(43) Pub. Date: Feb. 21, 2013

(54) METHOD AND APPARATUS FOR UPLINK INTERFERENCE CONTROL

(71) Applicants: Brian Martin, Surrey (GB); Keiichi Kubota, Surrey (GB); Tao Chen, Salo (FI)

(72) Inventors: Brian Martin, Surrey (GB); Keiichi Kubota, Surrey (GB); Tao Chen, Salo (FI)

(73) Assignee: RENESAS MOBILE CORPORATION, Toyko (JP)

(21) Appl. No.: 13/210,180

(22) Filed: Aug. 15, 2011

(51) Int. Cl. H04W 52/24

(52) U.S. Cl. 455/522

(57) ABSTRACT

A method and apparatus are provided to reduce interference in neighbor cells by limiting the uplink power of an interfering mobile terminal In this regard, a method is provided that includes generating a measurement report, wherein the measurement report includes interference measurement information measured from at least one neighbor cell. The method also includes causing the generated measurement report to be transmitted to a receiving station. The method may also include receiving a power level indication from the receiving station, wherein the indication causes a modification of transmission power.

### TECHNOLOGICAL FIELD

Embodiments of the present invention relate generally to communications technology and, more particularly, to methods and apparatus for uplink related improvements in signaling based interference control.

### BACKGROUND

The communications between a mobile terminal and a serving cell, such as the uplink communications from the mobile terminal to the serving cell, may sometimes create interference with neighbor cells. This interference may inhibit the operation of the neighbor cells or may at least cause the mobile terminal and/or the neighbor cells to operate less efficiently. In some operational states, such as a CELL_DCH state, the mobile terminal and the serving cell may monitor the neighbor cells in such a manner that instances of neighbor cell interference may be identified and the operation of the mobile terminal and/or the serving cell may be modified in such a manner as to reduce the potential for the neighbor cell interference. Indeed, in the CELL_DCH state, the neighbor cells may be added to the active set so as to be involved in uplink power control. In this regard, the mobile terminal may receive signals from the serving cell as well as the neighbor cells. As such, neighbor cells may identify instances in which the mobile terminal is creating interference such that the mobile terminal may reduce its uplink power in an effort to correspondingly reduce the neighbor cell interference. More particularly, for a mobile terminal operating in a CELL_DCH state, the uplink power from the mobile terminal may be controlled via relative grants from neighbor cells within the active set of the mobile terminal.

In other operational states, however, the mobile terminal may not communicate with the neighbor cells in the same manner and, as such, may not be able to identify instances of potential neighbor cell interference. For example, a mobile terminal in a CELL_FACH state may only receive signals from the serving cell. As such, in instances in which the mobile terminal is creating interference for the neighbor cells, the neighbor cells are unable to communicate with the mobile terminal in order to request that the power, such as the uplink power, be reduced in an effort to correspondingly reduce the neighbor cell interference. For example, in contrast to the relative grants from neighbor cells to a mobile terminal in a CELL_DCH state that serve to control the uplink power, a mobile terminal operating in the CELL_FACH state may not have similar control of its uplink power since the uplink power of the mobile terminal may only be controlled by the serving cell using absolute grants without consideration of possible neighbor cell interference. As such, a mobile terminal that is creating neighbor cell interference may impair the operation of the neighbor cells and, in some instances, may suffer from radio link failure.

In Release 8 of the Third Generation Partnership Project (3GPP) specification, an enhanced uplink for a mobile terminal in the CELL_FACH state in the idle mode was introduced. This enhanced uplink is termed a common enhanced dedicated channel (Common E-DCH). As such, mobile terminals may utilize the E-DCH in other radio resource control (RRC) states in addition to or other than the CELL_DCH state. Notwithstanding the potential for the creation of neighbor cell interference to be created by the uplink transmissions of a mobile terminal in the CELL_FACH state, it is anticipated that mobile terminals will frequently operate in the CELL_FACH state, such as to perform infrequent or burst data transmissions, and that operation of mobile terminals in the CELL_FACH state may increase as a result of the introduction of the E-DCH. As such, the issues relating to potential neighbor cell interference while a mobile terminal is operating in the CELL_FACH state may also become more frequent and problematic.

A number of signaling based methods have been proposed in an effort to provide some measure of interference control for the neighbor cells in instances in which a mobile terminal is operating in the CELL_FACH state. However the proposals have generally suffered from various drawbacks including, for example, increased complexity for the mobile terminal and/or the serving cell or the failure to address all use cases or scenarios.

### BRIEF SUMMARY

A method and apparatus are therefore provided according to an example embodiment to reduce interference in neighbor cells by limiting the uplink power of an interfering mobile terminal. In this regard, the method and apparatus of one embodiment may use enhanced dedicated channel “E-DCH” power control to limit the uplink power of a mobile terminal based on received neighbor cell interference levels. The mobile terminal may provide measurement reports on neighbor cell interference levels, for example in cellular forward access channel “CELL_FACH” containing the relevant measurement information such as uplink power headroom “UPH,” the current serving grant, neighbor cells detected/measured, and/or neighbor cell interference information. Thus, the method and apparatus of an embodiment may optimize measurement reports from the mobile terminal while providing a decrease in interference between neighbor cells.

In one embodiment, a method is provided that includes generating a measurement report, wherein the measurement report includes interference measurement information measured from at least one neighbor cell. The method of this embodiment also includes causing the generated measurement report to be transmitted to a receiving station. The method may also include receiving a power level indication from the receiving station, wherein the indication causes a modification of transmission power.

In another embodiment, an apparatus is provided that includes at least one processor and at least one memory including computer program code with the at least one memory and the computer program code configured to, with the at least one processor, cause the apparatus at least to generate a measurement report, wherein the measurement report includes interference measurement information of at least one neighbor cell. The at least one memory and the computer program code are also configured in one embodiment to, with the at least one processor, cause the apparatus to cause the generated measurement report to be transmitted to a receiving station. The at least one memory and the computer program code are also configured in one embodiment to, with the at least one processor, cause the apparatus to receive a power level indication from the receiving station, wherein the indication results in a modified uplink power level.

In a further embodiment, a computer program product is provided that includes at least one non-transitory computer-readable storage medium having computer-readable program instructions stored therein with the computer-readable program instructions including program instructions configured to generate a measurement report, wherein the measurement report includes interference measurement information of at least one neighbor cell. The computer-readable program instructions of this embodiment also include program instructions configured to cause the generated measurement report to be transmitted to a receiving station. The computer-readable program instructions of this embodiment also include program instructions configured to receive a power level indication from the receiving station, wherein the indication results in a modified uplink power level.

In one embodiment, an apparatus is provided that includes means for generating a measurement report, wherein the measurement report includes interference measurement information measured from at least one neighbor cell. The apparatus also includes means for causing the generated measurement report to be transmitted to a receiving station. The apparatus may also include means for receiving a power level indication from the receiving station, wherein the indication causes a modification of transmission power.

In one embodiment, a method is provided that includes receiving a measurement report from a reporting station. The method of this embodiment may also include determining neighbor cell interference information based on the received measurement information. Additionally, the method may include causing a serving grant to be modified for a mobile terminal.

In another embodiment, an apparatus is provided that includes at least one processor and at least one memory including computer program code with the at least one memory and the computer program code configured to, with the at least one processor, cause the apparatus at least to receive a measurement report from a reporting station. The at least one memory and the computer program code of one embodiment are also configured to, with the at least one processor, cause the apparatus to determine neighbor cell interference information based on the received measurement information. Additionally, the at least one memory and the computer program code may be configured to, with the at least one processor, cause the apparatus to cause a serving grant to be modified for a mobile terminal.

In a further embodiment, a computer program product is provided that includes at least one non-transitory computer-readable storage medium having computer-readable program instructions stored therein with the computer-readable program instructions including program instructions configured to receive a measurement report from a reporting station. The computer-readable program instructions of this embodiment also include program instructions configured to determine neighbor cell interference information based on the received measurement information. Additionally, the computer-readable program instructions of this embodiment also include program instructions configured to cause a serving grant to be modified for a mobile terminal.

In one embodiment, an apparatus is provided that includes means for receiving a measurement report from a reporting station. The apparatus of this embodiment may also include means for determining neighbor cell interference information based on the received measurement information. Additionally, the apparatus may include means for causing a serving grant to be modified for a mobile terminal.

### BRIEF DESCRIPTION OF THE SEVERAL VIEWS OF THE DRAWINGS

Having thus described the example embodiments of the invention in general terms, reference will now be made to the accompanying drawings, which are not necessarily drawn to scale, and wherein:

FIG. 1 is a schematic representation of a system in which an example embodiment of the present invention is operable;

FIG. 2 is a schematic representation of an environment in which an example embodiment of the present invention is operable;

FIG. 3 is a block diagram of an apparatus that may be specifically configured to implement an example embodiment of the present invention;

FIG. 4 is a flowchart illustrating the operations performed by a mobile terminal in accordance with one embodiment of the present invention;

FIG. 5 is a flowchart illustrating the operations performed by an access point in accordance with one embodiment of the present invention;

FIG. 6 is a flowchart illustrating the operations performed by an access point and radio network controller (“RNC”) in accordance with one embodiment of the present invention;

FIG. 7 is a signaling flow diagram illustrating the messages exchanged between a RNC, an access point and a mobile terminal in accordance with one embodiment of the present invention; and

FIG. 8 is a signaling flow diagram illustrating the messages exchanged between an access point and a mobile terminal in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product are disclosed herein for reducing interference in neighbor cells by limiting uplink power of a mobile terminal. As such, the method, apparatus and computer program product of one embodiment may enable a serving cell to use E-DCH power control to limit uplink power by modifying an absolute grant value. Further the method, apparatus and computer program product provide for mobile terminal based measurement reporting. By way of example, the mobile terminal, in a CELL_FACH state, may provide measurement reports that identify interference levels between a mobile terminal and a neighbor cell. In an example embodiment, the measurement reports are sent to an RNC and in other embodiments the measurement reports may be sent to an access point such acting as a serving cell.

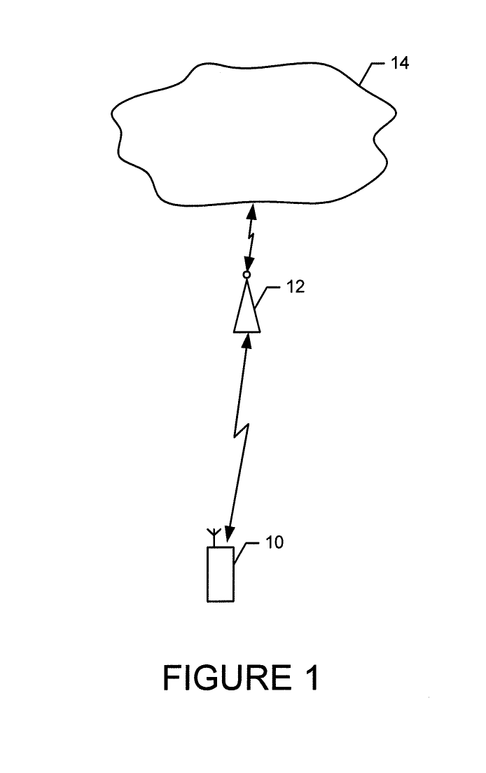

Although the method, apparatus and computer program product may be implemented in a variety of different systems, one example of such a system is shown in FIG. 1, which includes a first communication device (e.g., mobile terminal 10) that is capable of communication via an access point 12, such as a base station, a Node B, an evolved Node B (eNB) or the like, with a network 14 (e.g., a core network). While the network may be configured in accordance with LTE or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 14 may include a collection of various different nodes, devices or functions that may be in communication with each other via corresponding wired and/or wireless interfaces. For example, the network may include one or more access points 12, each of which may serve a coverage area divided into one or more cells. The access point or other communication node could be, for example, part of one or more cellular or mobile networks or public land mobile networks (PLMNs). In turn, other devices such as processing devices (e.g., personal computers, server computers or the like) may be coupled to the mobile terminal and/or other communication devices via the network.

A communication device, such as the mobile terminal 10 (also known as user equipment (UE)), may be in communication with other communication devices or other devices via the access point 12 and, in turn, the network 14. In some cases, the communication device may include an antenna for transmitting signals to and for receiving signals from an access point.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal 10 to operate in a particular way or execute specific functionality when the instructions are executed by the one or more processors. The mobile terminal may also include communication circuitry and corresponding hardware/software to enable communication with other devices and/or the network 14.

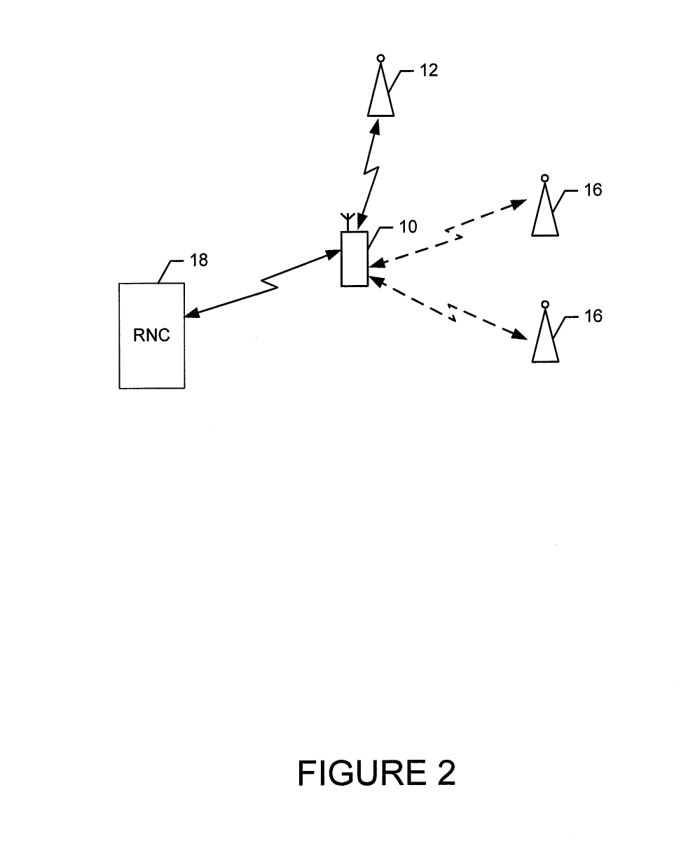

As is shown in FIG. 2, the mobile terminal 10 and the access point 12 may operate in an environment that comprises a plurality of access points, such as access point 12 and neighbor cells 16, and an RNC 18. For example, as shown with respect to FIG. 2, the access point 12 may be a serving cell with respect to the mobile terminal 10. The plurality of access points in the vicinity of the mobile terminal 10 that are not currently serving the mobile terminal may be identified as neighbor cells 16. In some situations, the neighbor cells 16 may receive interference from the mobile terminal 10. As is further shown in FIG. 2, the mobile terminal 10 may be in communication with an RNC 18 either directly or through an access point, such as access point 12.

In situations where an RNC 18 coordinates and/or controls inter-cell uplink interference, the mobile terminal 10 may be configured to generate a measurement report for a list of neighbor cells. The mobile terminal 10 is then configured to transmit the measurement report to the RNC 18. Alternatively or additionally the RNC 18 may be configured to determine interference measurements for the one or more neighbor cells, in that circumstance, the RNC 18 may determine one or more neighbor cells 16 that may be receiving interference from the mobile terminal 10.

Generally, when a mobile terminal 10 is in a CELL_FACH state, a measurement report including a traffic volume measurement (TVM) may be provided to the RNC 18 and/or the access point 12. Alternatively or additionally, UPH and current serving grant information may also be included in the measurement report transmitted by the mobile terminal 10. Alternatively or additionally, UPH and the current serving grant information may be obtained from the serving cell such as access point 12.

The measurement report may be transmitted by the mobile terminal 10 to the access point 12 and/or the RNC 18 as a single report or may be sent as multiple reports. In an embodiment where multiple reports are sent, a new network interface may be opened to obtain measurement information from neighbor cells and to synchronize the received data.

In an example embodiment, the RNC 18 may be configured to receive the measurement report from mobile terminal 10. The measurement report may include, but is not limited to, uplink interference information (e.g., Received Total Wideband Power “RTWP”, Received Scheduled E-DCH Power Share “RSEPS”) of a mobile terminal 10 and its neighbor cells 16. The uplink interference information may also be obtainable by the RNC 18 using a measurement report received from an access point 12. 100371 In an example embodiment, based on the information from RNC 18, the serving cell, such as access point 12, may adjust a mobile terminal's E-DCH power allocation or reduce scheduling of the mobile terminal to limit the inter-cell interference. Alternatively or additionally, the RNC 18 may also limit the maximum E-DCH power ratio of the interfering mobile terminal 10 by sending node b application part NBAP message “Radio Link Reconfiguration” to the serving cell, such as access point 12. Alternatively or additionally a new “Maximum allowed E-DCH power ratio” can be added into the “Radio link reconfiguration” or other NBAP messages.

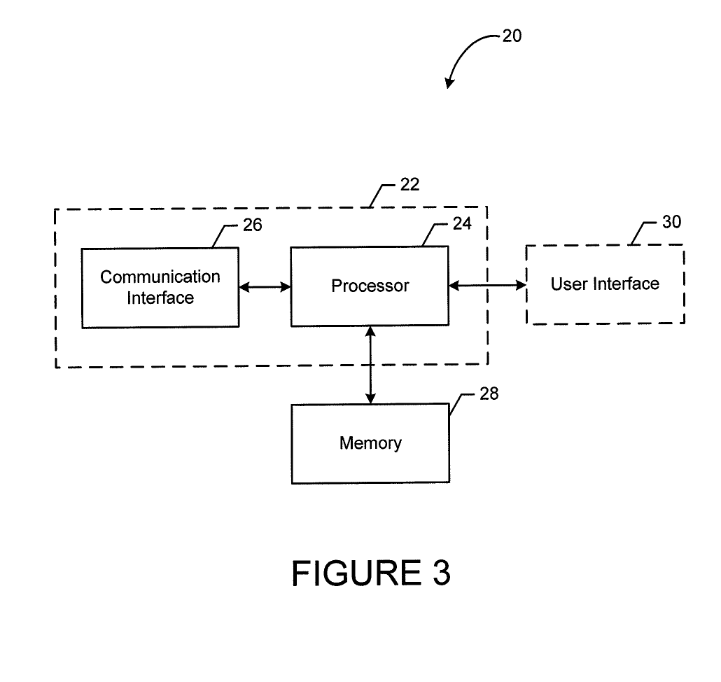

In one embodiment, for example, the mobile terminal 10, the access point 12, the neighboring nodes 16, and/or the RNC 18 may be embodied as or otherwise include an apparatus 20 as generically represented by the block diagram of FIG. 3. While the apparatus may be employed, for example, by a mobile terminal 10, an access point 12 or an RNC 18, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 28 that may be in communication with or otherwise control a communications interface 26 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. The apparatus 20 need not always include a user interface. For example, in instances in which the apparatus is embodied as an access point 12 or an RNC 18, the apparatus may not include a user interface. As such, the user interface is shown in dashed lines in FIG. 3.

The communications interface 26 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 14 and/or any other device or module in communication with the processing circuitry 22, such as between the mobile terminal 10 and the access point 12. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

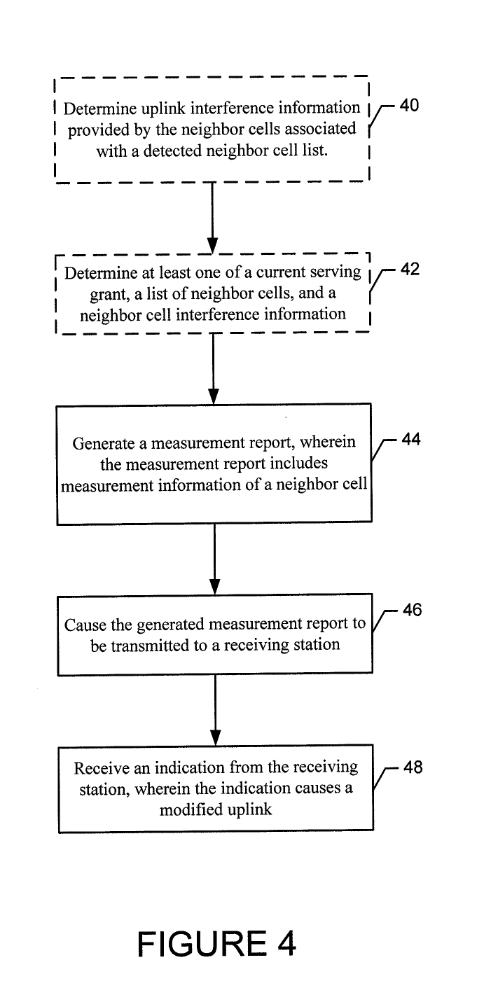

FIGS. 4-6 are flowcharts illustrating the operations performed by a method, apparatus and computer program product, such as apparatus 20 of FIG. 3, from the perspective of a mobile terminal 10, an access point 12, a neighbor cell 16 and an RNC 18 in accordance with one embodiment of the present invention are illustrated. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 28 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 4-6, when executed, convert a computer or processing circuitry into a particular machine configured to perform an example embodiment of the present invention. Accordingly, the operations of each of FIGS. 4-6 define an algorithm for configuring a computer or processing circuitry 22, e.g., processor, to perform an example embodiment. In some cases, a general purpose computer may be provided with an instance of the processor which performs the algorithm of a respective one of FIGS. 4-6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

Although shown in the flowcharts in a somewhat abbreviated manners, certain ones of the operations above may be modified or further amplified as described below. Moreover, in some embodiments additional optional operations may also be included (some examples of which are shown in dashed lines in FIGS. 4-8). It should be appreciated that each of the modifications, optional additions or amplifications below may be included with the operations above either alone or in combination with any others among the features described herein.

FIG. 4 is a flowchart illustrating the operations performed in accordance with one embodiment of the present invention As shown in operation 40 of FIG. 4, for example, the apparatus 20 embodied by the mobile terminal 10 may include means, such as the processing circuitry 22, the processor 24 or the like, for determining neighbor cell uplink interference info provided by neighbor cells. The cells neighboring the mobile terminal 10 may be associated with a neighbor cell list. For example, the apparatus 20 embodied by the mobile terminal 10 may obtain neighbor cell uplink interference information that is read from a system information block (“Sib”), such as SIB7 and/or SIB 5. Alternatively or additionally, UPH and a current serving grant may be included in the neighbor cell interference information. Alternatively or additionally, UPH may be obtained from the scheduling information (“SI”) carried in media access control layer I packet data unit “MAC-i PDU,” and the current serving grant could be roughly derived based on the E-DCH Transport Format Combination Identifier “E-TFCI” in the last E-DCH transmission.

As shown in operation 42 of FIG. 4, for example, the apparatus 20 embodied by the mobile terminal 10 may include means, such as the processing circuitry 22, the processor 24, or the like, for determining at least one of a UPH, a current serving grant, a list of neighbor cells and/or neighbor cell interference information. For example, such information may be usable by the access point 12 and/or the RNC 18 to determine interference information between the mobile terminal 10 and the neighbor cells 16.

As shown in operation 44 of FIG. 4, for example, the apparatus 20 embodied by the mobile terminal 10 may include means, such as the processing circuitry 22, the processor 24 or the like, for generating a measurement report. The measurement report may include measurement information such as the measurement information determined with respect to operation 42. The measurement report may also include neighbor cell measurement information (e.g., scrambling code, power level measured, energy per chip/power density in the band “Ec/No”) and the serving cell information (e.g., UPH, serving grant, power, Ec/No).

Further, as shown in operation 46 of FIG. 4, for example, the apparatus 20 embodied by the mobile terminal 10 may include means, such as the processing circuitry 22, the processor 24, the communications interface 26 or the like, for causing the generated measurement report to be transmitted to a receiving station. In an embodiment, the receiving station is the RNC 18 and in alternate embodiments the receiving station is the access point 12. In an embodiment, where the measurement report is transmitted to the RNC 18, the measurement report may include measurement information such as that information described with reference to operation 42. In an embodiment, where the access point 12 is the receiving station, then the measurement report may also include the measurement information determined with respect to operations 40 and 42.

As shown in operation 48, for example, the apparatus 20 embodied by the mobile terminal 10 may include means, such as the processing circuitry 22, the communications interface 26 or the like, for receiving an indication from the receiving station. The indication causes the uplink to be modified. For example, the mobile terminal 10 may receive an indication that the mobile terminal's E-DCH power allocation has been modified or the scheduling of the mobile terminal 10 may be limited. In response to, or as a result of, the indication, the mobile terminal 10 may have its power level altered. Alternatively or additionally, the indication of a modified uplink may be determined by the mobile terminal 10 based on modified settings at an access point 12 or the RNC 18.

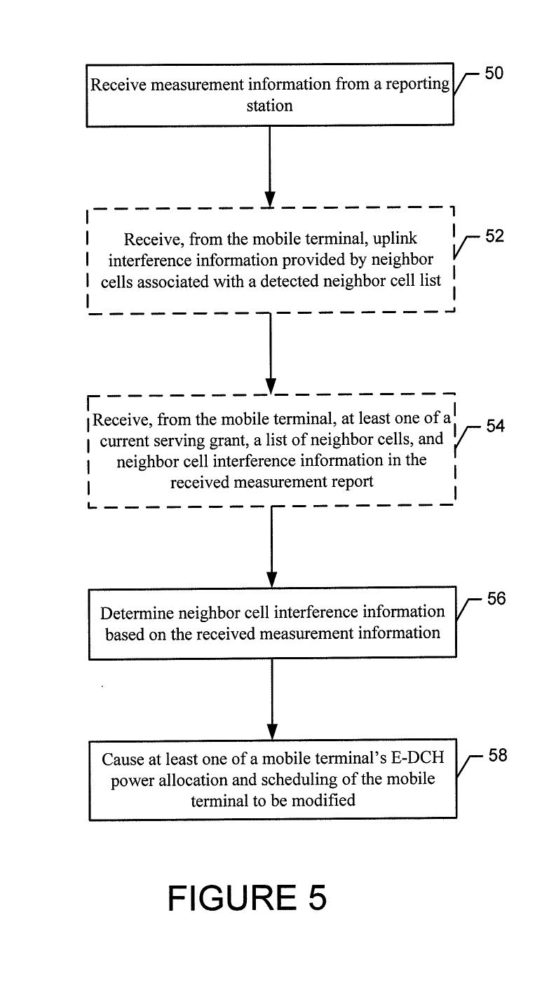

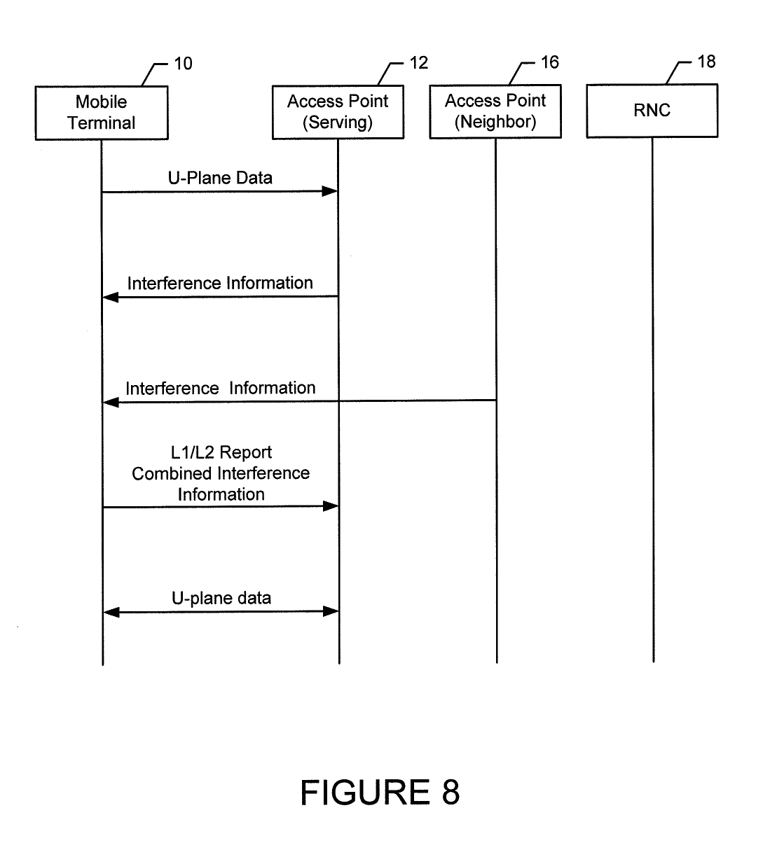

FIG. 5, illustrates an embodiment of the current invention which depicts the interaction between the mobile terminal 10 and the access point 12. See also the signaling flow diagram shown in FIG. 8. As shown in operation 50 of FIG. 5, the apparatus 20 embodied by the access point 12 may include means, such as the processing circuitry 22, the processor 24, the communications interface 26 or the like, for receiving measurement information from a reporting station, such as the mobile terminal 10. The measurement information may be further defined with respect to the measurement reports referenced in operations 44 and 46 of FIG. 4.

As shown in operation 52 of FIG. 5, the apparatus 20 embodied by the access point 12 may include means, such as the processing circuitry 22, the processor 24, the communications interface 26 or the like, for receiving, from the mobile terminal, uplink interference by neighbor cells within the neighbor cell list. For example, the mobile terminal 10, instead of the RNC 18, may provide system information, such as SIB7 and SIBS information, to the access point 12 thereby advantageously resulting in less impact to the network.

As shown in operation 54 of FIG. 5, the apparatus 20 embodied by the access point 12 may include means, such as the processing circuitry 22, the processor 24, the communications interface 26 or the like, for receiving, from the mobile terminal 10, at least one of a current serving grant, a list of neighbor cells, and neighbor cell interference information. Other uplink variables may also be received. These variables include but are not limited to UPH and/or a determined uplink interference level for a neighbor cell, such as neighbor cell 16.

As shown in operation 56 of FIG. 5, the apparatus 20 embodied by the access point 12 may include means, such as the processing circuitry 22, the processor 24, or the like, for determining neighbor cell interference information based on the received measurement information, such the measurement information received in operations 50-54 of FIG. 5. In an example embodiment, the access point 12, such as the processor 24m may use an interference control algorithm to determine a level of interference between a mobile terminal and a neighbor cell. One example interference control algorithm may include:
IF: (the current serving grant>threshold_1 && UPH<threshold_2 && uplink InteferenceLevel_NeighborCell>Threshold_3) where threshold_1, threshold_2 and threshold_3 are predetermined threshold variables.
THEN: the Absolute Grant based power control may be enabled. The E-DCH absolute grant channel “E-AGCH” carrying the maximum power ratio information may be sent to the corresponding mobile terminal which sent the measurement report.

The example interference control algorithm described above, for example, determines if the current serving grant is above a predetermined threshold and if the UPH is below a predetermined threshold. If these conditions are both true, then the mobile terminal 10 may be controlled, such as via E-AGCH, to reduce its transmission power.

As shown in operation 58 of FIG. 5, the apparatus 20 embodied by the access point 12 may include means, such as the processing circuitry 22, the processor 24, the communications interface 26 or the like, for causing a E-DCH power allocation or scheduling of the mobile terminal to be modified. By modifying the E-DCH power allocation or the scheduling of the mobile terminal, the access point 12 may effectively manage inter-cell interference.

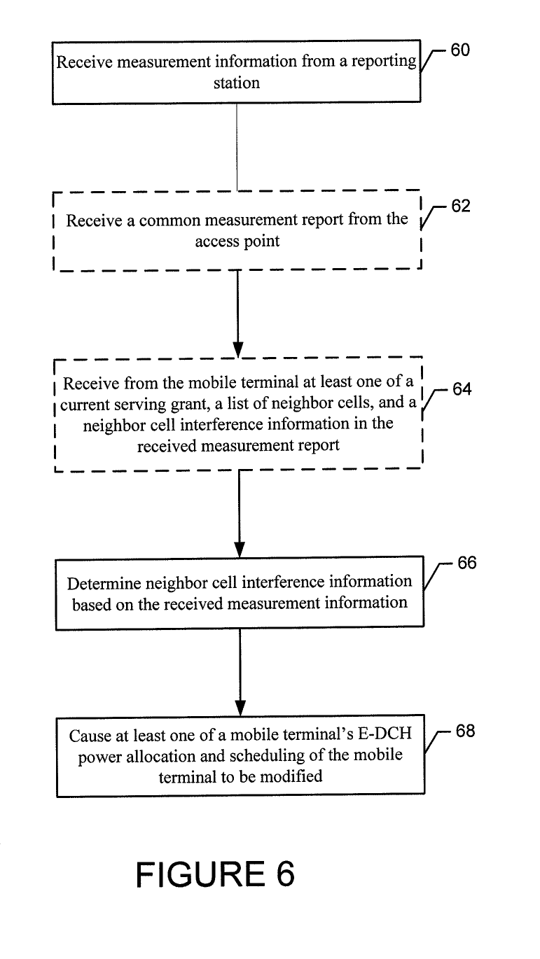

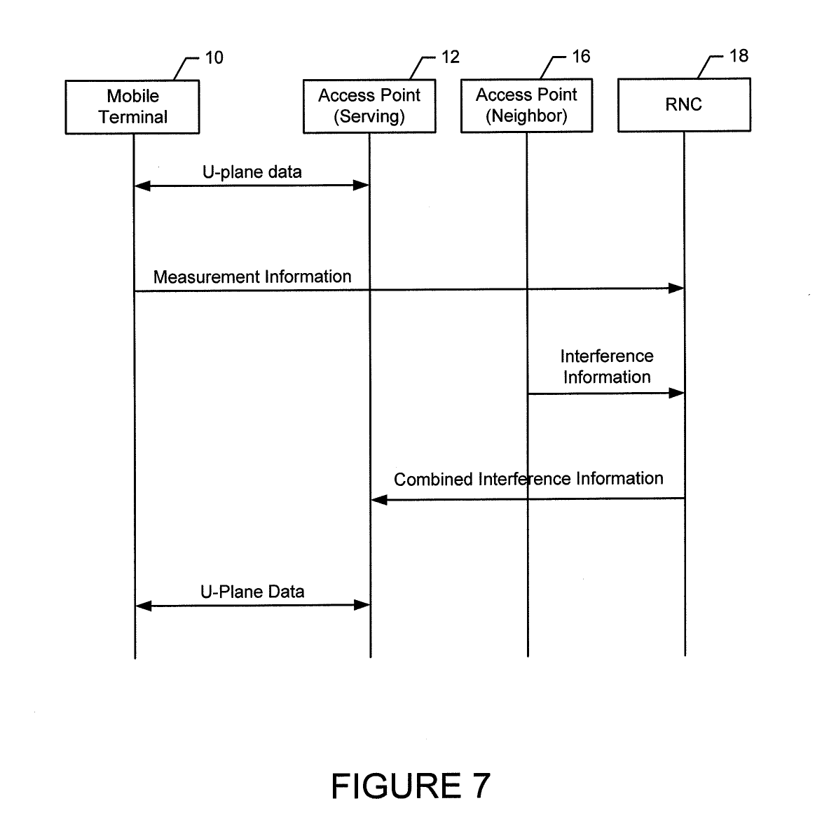

FIG. 6 is a flowchart illustrating the operations performed in accordance with one embodiment of the present invention. FIG. 6 further illustrates an embodiment of the current invention implemented using communications between the mobile terminal 10, the access point 12 and the RNC 18. See also the signaling flow diagram shown in FIG. 7. As shown in operation 60 of FIG. 6, the apparatus 20 embodied by the RNC 18 may include means, such as the processing circuitry 22, the processor 24, the communications interface 26 or the like, for receiving measurement information from a reporting station, such as the mobile terminal 10. The measurement information is further defined with respect to the measurement reports referenced in operations 44 and 46 of FIG. 4.

As shown in operation 62, of FIG. 6, the apparatus 20 embodied by the RNC 18 may include means, such as the processing circuitry 22, the processor 24, the communications interface 26 or the like, for receiving a common measurement report from an access point, such as from access point 12. For example, the uplink interference information can be obtained by the RNC 18 using the measurement report, such as a common measurement report as defined by, from the access point, such for example via an interface, such as an Iub interface. The common measurement report may be periodically triggered, triggered by an event, and/or the like.

As shown in operation 66 of FIG. 6, the apparatus 20 embodied by the RNC 18 may include means, such as the processing circuitry 22, the processor 24, or the like, for determining neighbor cell interference information based on the received measurement information. In an example embodiment, the RNC 18, such as the processor 24, may use an interference control algorithm to determine a level of interference between a mobile terminal, such as mobile terminal 10 and a neighbor cell. An example interference algorithm is further described with respect to operation 56.

As shown in operation 68 of FIG. 6, the apparatus 20 embodied by the RNC 18 may include means, such as the processing circuitry 22, the processor 24, the communications interface 26 or the like, for causing the mobile terminal's E-DCH power allocation and/or scheduling of the mobile terminal to be modified. For example, since the RNC 18 has the neighbor cell interference information and a connection with the interfering mobile terminal, the RNC 18 may limit the maximum E-DCH power ratio of the interfering mobile terminal 10 by sending NBAP message “Radio Link Reconfiguration” to the serving cell, such as the access point 12. Alternatively or additionally a new information element “IE” “Maximum allowed E-DCH power ratio” can be added into the “Radio link reconfiguration” or other NBAP messages.

FIG. 7 is a signaling (e.g., Layer 3 “L3” signaling) flow diagram illustrating the messages exchanged between an RNC, such as RNC 18, an access point, such as access point 12 and a mobile terminal, such as mobile terminal 10 in accordance with one embodiment of the present invention. As is shown in FIG. 7, various user plane data is exchanged between a mobile terminal 19 and an access point 12. In one embodiment and as described in detail herein, the mobile terminal 10 is configured to transmit the measurement report message to the RNC 18. For example, the measurement report may include the neighbor cell measurement information (e.g., scrambling code, power level measured, Ec/No) and the serving cell information (e.g. UPH, serving grant, power, Ec/No).

The RNC 18 is configured to coordinate between access points (serving and neighbor cells). The serving cell, such as access point 12, is therefore configured to receive a combined information report. A combined information report may include neighbor interference information and/or measurement information. Alternatively or additionally the RNC 18 could also receive the UPH and the serving grant information from the serving cell, such as access point 12. Alternatively or additionally, the RNC 18 may receive and process the neighbor cell interference information and then transmit the processed interference information, such as measurement information and/or other information such as a power down request, to the access point 12.

The serving cell, such as the access point 12 is further configured to modify (shown as a u-plane signal) the absolute serving grant for the mobile terminal 10 in order to reduce the mobile terminal output power in case of interference to neighbors. The RNC 18 may also limit the maximum E-DCH power ratio of the interfering mobile terminal by sending NBAP message “Radio Link Reconfiguration” to the serving cell with a new “Maximum Allowed E-DCH Power Ratio”.

FIG. 8 is a signaling (e.g., Layer 1 “L1”/Layer 2 “L2” signaling) flow diagram illustrating the messages exchanged between an access point and a mobile terminal in accordance with one embodiment of the present invention. In this example embodiment, the mobile terminal provides the interference information from the detected neighbors to the serving cell. The mobile terminal obtains the uplink interference information, e.g., SIB5 and SIB7, from the neighbor cells. The measurement report is transmitted to the access point 12 such as over a standalone MAC-i PDU or attached in the end of MAC-i PDU.

Alternatively or additionally, L1 signaling may also be used. For example, the mobile terminal 12 may send an indication, such as al bit indicator, to request the E-DCH power up/down. For example the “Happy” Bit carried in E-DCH Dedicated Physical Control Channel “E-DPCCH” may be reused. In this example embodiment, if the mobile terminal 10 is causing the high interference according to the configured measurement, the mobile terminal may send a “Happy” bit so that access point 12 may not allocate the higher data rate for the interfering mobile terminal anymore. Moreover, access point may adjust down E-DCH power ratio such as via E-DCH Absolute Grant Channel “E-AGCH”/E-DCH Relative Grant Channel “E-RGCH” if mobile terminal 10 sends the “Happy” bit consecutively.

Advantageously, the apparatus and methods described herein provide simple and accurate interference control. The apparatus and methods are configured to avoid radio link failures because the serving cell is modifying the uplink power. Further, in an embodiment, the RNC 18 may operate the interference control methods disclosed herein jointly with the load control and admission control functions to further improve the overall system performance.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
generating, using a processor, a measurement report, wherein the measurement report includes interference measurement information measured from at least one neighbor cell;
causing the generated measurement report to be transmitted to a receiving station; and
receiving a power level indication from the receiving station, wherein the indication causes a modification of transmission power.

2. A method of claim 1, wherein the receiving station is at least one of an access point and a radio network controller.

3. A method of claim 1, wherein generating a measurement report further comprises determining at least one of an uplink power headroom, a current serving grant, a listing of neighbor cells, and a neighbor cell interference information.

4. A method of claim 1, wherein generating a measurement report further comprises determining uplink interference information from at least one neighbor cell associated with a neighbor cell list.

5. A method comprising:
receiving a measurement report from a reporting station;
determining, using a processor, neighbor cell interference information based on the received measurement information; and
causing a serving grant to be modified for a mobile terminal.

6. A method of claim 5, wherein causing a serving grant to be modified further comprises causing at least one of a mobile terminal's enhanced dedicated channel “E-DCH” power allocation and scheduling of the mobile terminal to be modified.

7. A method of claim 5, wherein the reporting station is a mobile terminal.

8. A method of claim 7, further comprising
receiving, from the mobile terminal, uplink interference information read from at least one of system information block 7 or system information block 5 of the neighbor cells associated with the neighbor cell list; and
receiving, from the mobile terminal, at least one of a current serving grant, a listing of neighbor cells, and a neighbor cell interference information with the received measurement report.

9. A method of claim 5, wherein the reporting station includes at least one mobile terminal and an at least one access point.

10. A method of claim 9, further comprising:
receiving a measurement report from the access point; and
receiving from the mobile terminal at least one of an uplink power headroom, a current serving grant, a listing of neighbor cells, and a neighbor cell interference information with the received measurement report.

11. An apparatus comprising:
at least one processor; and
at least one memory including computer program code, the at least one memory and the computer program code configured to, with the at least one processor, cause the apparatus at least to:
generate a measurement report, wherein the measurement report includes interference measurement information from at least one neighbor cell;
cause the generated measurement report to be transmitted to a receiving station; and
receive a power level indication from the receiving station, wherein the indication results in a modified uplink power level.

12. An apparatus according to claim 11, wherein the receiving station is at least one of an access point and a radio network controller.

13. An apparatus according to claim 11, wherein the at least one memory including the computer program code is further configured to, with the at least one processor, cause the apparatus to determine at least one of an uplink power headroom, a current serving grant, a listing of neighbor cells, and a neighbor cell interference information.

14. An apparatus according to claim 11, wherein the at least one memory including the computer program code is further configured to, with the at least one processor, cause the apparatus to determine uplink interference information from at least one neighbor cell associated with a neighbor cell list.

15. An apparatus comprising:
at least one processor; and
at least one memory including computer program code, the at least one memory and the computer program code configured to, with the at least one processor, cause the apparatus at least to:
receive a measurement report from a reporting station;
determine neighbor cell interference information based on the received measurement information; and
cause a serving grant to be modified for a mobile terminal.

16. An apparatus according to claim 15, wherein the at least one memory including the computer program code is further configured to, with the at least one processor, cause the apparatus to cause at least one of a mobile terminal's enhanced dedicated channel “E-DCH” power allocation and scheduling of the mobile terminal to be modified.

17. An apparatus according to claim 15, wherein the reporting station is a mobile terminal.

18. An apparatus according to claim 17, wherein the at least one memory including the computer program code is further configured to, with the at least one processor, cause the apparatus to
receive, from the mobile terminal, uplink interference information from at least one neighbor cell associated with the neighbor cell list; and
receive, from the mobile terminal, at least one of a current serving grant, a listing of neighbor cells, and neighbor cell interference information with the received measurement report.

19. An apparatus according to claim 15, wherein the reporting station includes at least one mobile terminal and an at least one access point.

20. An apparatus according to 19, wherein the at least one memory including the computer program code is further configured to, with the at least one processor, cause the apparatus to
receive a measurement report from the access point; and
receive from the mobile terminal at least one of a current serving grant, a listing of neighbor cells, and a neighbor cell interference information with the received measurement report.
